(19) United States
(12) Patent Application Publication
(10) Pub. No.: US 2026/0229554 A1
(43) Pub. Date: Aug. 6, 2026

(54) METHODS FOR RECOVERING MATERIALS FROM SOLID OXIDE FULL-CELLS AND SOLID OXIDE CELLS

(71) Applicant: Battelle Energy Alliance, LLC, Idaho Falls, ID (US)

(72) Inventors: Wei Wu, Idaho Falls, ID (US); Luis A. Diaz Aldana, Idaho Falls, ID (US); Dong Ding, Idaho Falls, ID (US); Meng Shi, Idaho Falls, ID (US)

(21) Appl. No.: 19/530,098

(22) Filed: Feb. 4, 2026

Related U.S. Application Data
(60) Provisional application No. 63/754,236, filed on Feb. 5, 2025.

(51) Int. Cl. H01M 8/008; C01F 17/224; C01G 51/04; C01G 53/04; C22B 1/24; C22B 3/00; C22B 7/00; C22B 59/00

(52) U.S. Cl. CPC H01M 8/008; C01F 17/224; C01G 51/04; C01G 53/04; C22B 1/24; C22B 7/007; C22B 23/0461; C22B 59/00

(57) ABSTRACT

A method for recovering a material from a solid oxide full-cell, the method comprising comminuting a solid oxide full-cell to produce a powder and dissolving the powder to form a leaching solution. One or more materials is removed from the leaching solution and recovered. Additional methods for recovering a material from a solid oxide full-cell are also disclosed, as well as methods for recovering a material from a solid oxide cell.

### CROSS-REFERENCE TO RELATED APPLICATIONS

This application claims the benefit under 35 U.S.C. § 119(e) of U.S. Provisional Patent Application Ser. No. 63/754,236, filed Feb. 5, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to a method for recovering elements from waste materials. In particular, embodiments of the disclosure relate to a method for recovering materials from solid oxide cells such as solid oxide electrolyzers.

### BACKGROUND

Hydrogen production from water electrolysis powered with carbon-free renewable energy is a desirable and rapidly growing approach that may figure prominently in a variety of decarbonization efforts. A “solid oxide cell” refers to a general electrochemical device that uses a solid oxide electrolyte, while a “solid oxide electrolyzer” specifically describes a solid oxide cell operating in reverse mode to split water into hydrogen and oxygen using electricity, essentially acting as an electrolysis cell that utilizes a solid oxide electrolyte at high temperatures. Both technologies share similar components but function differently depending on the desired outcome-generating electricity in a fuel cell mode or producing hydrogen in an electrolysis mode. Under this technical category, solid oxide electrochemical cells (SOCs) (including solid oxide electrolyzers (SOEs) and solid oxide fuel cells (SOFCs)) that operate at intermediate temperatures (from about 300° C. to about 800° C.) may leverage both electrical and thermal energy produced by nuclear power and have demonstrated the highest energy efficiency among all electrolyzer technologies. However, manufacturing SOCs (e.g., SOEs) is highly dependent on significant amounts of critical raw materials (CRM). It is estimated that over one ton of waste ceramic material is generated in the production of a 1 megawatt solid oxide electrolyzer stack. SOE recycling methods are currently limited and focus on the intrinsic value of recoverable critical materials.

### BRIEF SUMMARY

A method for recovering a material from a solid oxide full-cell is disclosed. The method comprises comminuting a solid oxide full-cell to produce a powder. The powder is dissolved to form a leaching solution. One or more materials are removed from the leaching solution and recovered.

Further disclosed is a method for recovering a material from a solid oxide full-cell comprising comminuting a solid oxide full-cell comprising one or more of a perovskite electrolyte material and a metal material to produce a powder. The powder is dissolved in H₂SO₄ exhibiting a concentration of from about 0.25 Molar (M) H₂SO₄ to about 1 M H₂SO₄ to form a leaching solution. One or more of a perovskite electrolyte material and a metal material is removed from the leaching solution and recovered.

Further disclosed is a method for recovering a material from a solid oxide cell comprising separating a cathode from a solid oxide half-cell, the solid oxide cell comprising one or more of a perovskite electrolyte material, a metal material, cobalt, praseodymium, and nickel. One or more of the cobalt, praseodymium, and nickel are dissolved into a first leaching solution. One or more of the cobalt, praseodymium, and nickel are then removed from the first leaching solution. The method further comprises comminuting the solid oxide half-cell to produce a powder. The powder is dissolved to form a second leaching solution. One or more materials are removed from the second leaching solution.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a flow chart of a method of recovering a material from a solid oxide electrochemical cell in accordance with embodiments of the disclosure.

FIG. 2 is a process flow illustrating a method of recovering elements from a solid oxide electrochemical cell according to embodiments of the disclosure.

FIG. 3 is a process flow illustrating a method of recovering elements from a solid oxide electrochemical cell according to embodiments of the disclosure.

FIG. 4 is a side view of a cell for electrochemical leaching in accordance with embodiments of the disclosure.

### DETAILED DESCRIPTION

The illustrations presented herein are not actual views of any electrolyzer or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of an electrolyzer when utilized in a conventional manner. Furthermore, these terms may refer to an orientation of elements of any fuel cell as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Methods for recovering and recycling (e.g., reusing) materials from SOCs (e.g., SOEs) including ceramic composites and catalysts are disclosed. The SOC (e.g., SOE) may include components (e.g., cell components) formed from materials such as electrode materials and electrolyte materials, which contain transition metals and/or rare earth elements. The SOC (e.g., SOE) may include one or more chemical elements or chemical compounds classified as a critical raw material (CRM). For instance, the SOE may include a perovskite electrolyte material and metal electrode materials. The chemical elements or chemical compounds recovered from the SOE may be in the form of one or more of an elemental metal or a metal compound. The metal may be a transition metal or a rare earth element. The recovered material may be used as a precursor material to prepare a new SOC. The recovered materials may be sufficiently pure to fabricate new SOCs that are substantially free of physical defects. While recovering and recycling materials from SOEs is described herein, the methods may also be used to recover and recycle materials from solid oxide fuel cells (SOFCs), which conduct the reverse operation of SOEs.

The methods comprise a scalable, closed-loop recycling method that may be used for SOCS (e.g., SOEs) including both proton conducting solid oxide electrolyzers (p-SOEs) and oxygen ion conducting solid oxide electrolyzers (o-SOEs). The SOEs based on both o-SOE and p-SOE have been demonstrated for highly efficient green hydrogen production at elevated temperatures. The recovery of CRMs and cell components from the SOE may provide an alternative to the sourcing of the CRMs, may reduce the associated costs of producing the SOE, and may ensure a domestic supply alternative for forming the SOE. Since demand for hydrogen is expected to continue to increase, the demand for SOEs and the corresponding materials used in their production is also expected to increase. The SOEs used as a feedstock for the methods according to embodiments of the disclosure may include end-of-life SOEs, defective (e.g., nonfunctional) SOEs, and/or waste materials produced during fabrication of the SOEs. The method may include comminuting at least a portion of the SOE to form a powder, dissolving the powder to form a leaching solution, removing one or more materials from the leaching solution (e.g., one or more of conducting an electrochemical mediated process on the leaching solution to extract metals from the SOE powder and conducting a precipitation process to remove one or more materials from the leaching solution), and, optionally, conducting further refinement processes, such as one or more of selective precipitation, ion exchange, and solvent extraction, on the leaching solution to recover the metals and other materials at a desired purity. The methods according to embodiments of the disclosure may provide a stable supply chain of the CRMs, which may be used to form new SOEs. The physio-electrochemical method according to embodiments of the disclosure may also be conducted with minimum consumption of chemical reagents.

The methods may provide efficient and cost effective recycling of solid oxide electrolyzers containing, for example, an acid sensitive perovskite electrolyte (e.g., a doped barium zirconate) and CRMs including one or more of nickel, zirconium, and cobalt. Materials used in solid oxide electrolyzers (e.g., common electrolytes; oxygen ion conductors) include, for example, zirconia, yttria-stabilized zirconia, gadolinium-doped ceria, scandia-stabilized zirconia, lanthanum gallate, doped barium zirconate, barium cerate-zirconate, and doped ceria (e.g., samaria-doped ceria), among others. Anode materials may include nickel, nickel-yttrium-stabilized zirconia, nickel-gadolinium doped ceria, among others. Cathode materials may include cobalt, strontium, lanthanum strontium manganite, lanthanum strontium cobalt ferrite, among others. For example, a conventional SOE may comprise nickel in the fuel electrode (e.g., anode), cobalt and strontium in the oxygen electrode (e.g., cathode), rare earth elements such as yttrium and cerium in both the fuel electrode and the electrolyte, and lanthanum in the oxygen electrode. The methods according to embodiments of the disclosure may be used to recover one or more of the CRMs as an elemental metal or a metal compound (e.g., a metal sulfate, a metal oxide). The method may comprise comminution to prepare a powder form of the SOE, removing one or more materials (e.g., one or more metals and compounds) from the powder (e.g., removing by one or more of acid leaching, electrochemical leaching, precipitation, ion exchange, and solvent extraction), and SOE regeneration (e.g., preparing a new SOE from the recovered materials) using the obtained recycled raw materials and precursors.

The methods may comprise recycling of both structural and functional ceramics including recovered (e.g., industrial waste, manufacturing waste, end of life product waste) ceramic composites. The United States Department of Energy (DOE) has established a goal to reduce the cost of clean energy (e.g., the HYDROGEN SHOT™). The methods according to embodiments of the disclosure may support the goal of hydrogen production and may offer the potential to further reduce costs, while also providing a sustainable supply chain alternative for CRMs. The methods may achieve an electrolyte material recovery of about 90 percent by mass or greater, a critical raw material recovery of about 95 percent by mass or greater, and a fuel cell performance recovery of about 95 percent by mass or greater. The fuel cells may be fabricated using fresh (e.g., new) or commercially sourced materials or using recycled (e.g., recovered) materials. Performance recovery, as used herein, means that a fuel cell fabricated using recovered materials obtained according to embodiments of the disclosure may exhibit a performance that is about 95 percent or greater than that of a fuel cell fabricated from commercially sourced materials.

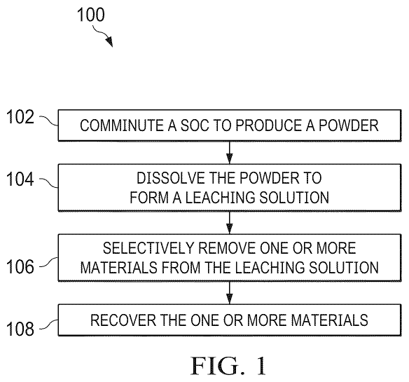

With reference to FIG. 1, a method 100 of recovering a material from a solid oxide cell (e.g., a full-cell) is disclosed. The method 100 may include comminuting 102 a solid oxide cell (e.g., an SOFC) to produce a powder. The method 100 may include dissolving 104 the powder to form a leaching solution. One or more materials (e.g., metals, compounds) may be selectively removed 106 (e.g., one or more of precipitated and electrochemically leached) from the leaching solution and recovered 108.

A solid oxide full-cell (e.g., a solid oxide electrolyzer full-cell) may comprise a cathode and a so-called half-cell. The half-cell may comprise an anode and an electrolyte. The full-cell may comprise the half cell (e.g., the anode and the electrolyte) and the cathode, with the electrolyte between the anode and cathode. The solid oxide full-cell is configured to conduct an electrolysis operation, supporting both half-reactions simultaneously, for steam reduction at the cathode (e.g., a hydrogen electrode) and oxygen ion oxidation and oxygen evolution at the oxygen electrode.

In embodiments of the disclosure, the method comprises separating a cathode from a solid oxide electrolyzer half-cell and comminuting the solid oxide electrolyzer half-cell into a powder. The separated cathode and the half-cell may be processed (e.g., recycled) separately. Thus, a process for recovering a material from the solid oxide cell (e.g., solid oxide electrolyzer) may comprise separating the cathode from the solid oxide electrolyzer half-cell. The cathode may be separated from the half-cell by known methods, such as mechanical scraping (e.g., mechanical detaching). A leaching solution may be prepared from the separated cathode. The cathode leaching solution may contain one or more elements, such as one or more transition metals, rare earth elements, etc. By way of example only, the elements in the cathode leaching solution may include cobalt, praseodymium, and nickel. The one or more elements may be removed from the cathode leaching solution by an extraction process (e.g., electrochemical leaching), a precipitation process, an ion exchange process, a solvent extraction process, another process, or a combination thereof. Conventional processes utilize nitric acid as a reagent for removing such elements. However, it is desirable to reduce or eliminate altogether the need for nitric acid. Using electrochemical leaching (e.g., electrochemical dissolution, electrochemical extraction) to remove the metal may reduce the need for nitric acid as a reagent, such as to less than about 65 weight percent of nitric acid. Extraction of the transition metals (e.g., Ni and Co) is dependent on the metal's oxidation state in the SOE and in the leaching solution. The method may include electrochemical generation of oxidizing agents and/or reducing agents that leach Co, Ni, and rare earth elements from the cathode leaching solution. The oxidizing agent and/or reducing agent may be one or more of hydrogen peroxide, iron, or cerium. One or more of the oxidizing agent and the reducing agent reacts with the powder feedstock to selectively dissolve the metal or metals of interest. One or more of the oxidizing agent and the reducing agent is itself reduced or oxidized. Since the process is conducted in an electrochemical system, the reduced or oxidized agent may be regenerated at the electrode of the electrochemical cell and the oxidizing agent and/or reducing agent may then be regenerated and reused for leaching more metal or metals from the powder feedstock. The method 100 may enable recovery of over about 90 percent by mass of the cobalt, nickel, and rare earth elements present in the powder feedstock.

Separately, the solid oxide electrolyzer half-cell may be comminuted to produce a powder. The powder may be dissolved to form a solution (e.g., a half-cell solution, a half-cell leaching solution). One or more materials (e.g., elements, metals, compounds) may be removed and recovered from the half-cell solution by one or more of extraction, precipitation, ion exchange, solvent extraction, another process, or a combination thereof. The recovered materials may be reused to form new SOCS (e.g., new SOEs).

In embodiments of the disclosure, a process for recovering a material from a solid oxide electrolyzer full-cell is disclosed. In this embodiment, the cathode is not first separated from the solid oxide electrolyzer half-cell. The process comprises comminuting a solid oxide electrolyzer full-cell to produce a powder, dissolving the powder to form a leaching solution, and removing one or more materials (e.g., one or more elements, metals, and compounds) from the leaching solution.

In this embodiment, comminuting the solid oxide electrolyzer to produce the powder may comprise comminuting substantially the entire full-cell (e.g., comminuting both the cathode and the half-cell together) to produce the powder (e.g., a full-cell powder). Thus, the method may comprise breaking down the cell as a whole into the powder. The powder may comprise, for example, one or more of nickel oxide, perovskite electrolyte (e.g., BaZr_{0.8}Y_{0.2}P_{3-δ} (BZY20), Ba(Zr_{c}Ce_{0.8-x}Y_{0.1}Yb_{0.1})O_{3-δ} (yttrium- and ytterbium-doped barium zirconate-cerate (BZCYYb)), for example, Ba(Zr_{0.4}Ce_{0.4}Y_{0.1}Yb_{0.1})O₃), yttria stabilized zirconia (YSZ), and cathode particles (e.g., PrNi_{0.6}Co_{0.4}O₃ (PNC) and LaₓSr₁₋ₓCo_{y}Fe₁₋₇O_{3-d} (LSCF)). The powder prepared from the full-cell may be dissolved to form a leaching solution (e.g., a full-cell leaching solution). One or more materials (e.g., elements, metals, compounds) may be removed (e.g., removed by one or more of extraction, precipitation, ion exchange, and solvent extraction) from the leaching solution. Electrochemical leaching (e.g., electrochemical dissolution, electrochemical extraction) may be used to extract the metals from the electrolyte materials. Downstream processes, such as one or more of selective precipitation, ion exchange, and solvent extraction, may be employed to recover dissolved air-side perovskites as precursors. For example, one or more CRMs (e.g., nickel, cobalt) may be dissolved in the solution and removed. The electrolyte powder may then be separately recovered. The recovered materials may be reused, such as in a manufacturing process to prepare a new cell. The recovered materials may be sufficiently pure to fabricate SOE cells that are substantially free of physical defects.

Comminuting may comprise one or more of grinding, crushing, cutting, vibrating, milling (e.g., ball milling, roller milling, cold-milling, knife milling, cryogenic rotor milling, planetary ball milling (PBM)), and sieving. Comminuting may be carried out for a time period of from about 15 minutes to about 60 hours, or from about 30 minutes to about 50 hours, although not limited. The comminuting may be conducted for an amount of time sufficient to achieve one or more of a desired particle size of the powder, a desired particle size distribution, and a desired specific surface area of the particles. The particle size may be on the order of micrometers or nanometers. Comminuting may be carried out at a temperature of from about −20° C. (e.g., cryogenic milling) to about 25° C. (e.g., ambient temperature), although not limited.

In embodiments of the disclosure, comminuting a solid oxide electrolyzer to produce a powder comprises comminuting a solid oxide electrolyzer using a cryogenic rotor mill to produce micrometer sized particles and comminuting the micrometer sized particles using a planetary ball mill to produce nanometer sized particles.

The process may, optionally, further comprise drying the powders. The powders may be dried in an oven or allowed to dry naturally (e.g., dried in an ambient atmosphere). The powder may be dried at a temperature of from about 15° C. to about 160° C., from about 25° C. to about 160° C., from about 70° C. to about 160° C., or from about 90° C. to about 140° C., although not limited.

The produced powder may be dissolved in a liquid to form a leaching solution. The powder may be dissolved in one or more of water (e.g., weakly acidic water), a solvent, an acid, and combinations thereof. The powder may be dissolved in an inorganic acid comprising one or more of H₂SO₄, HCl, and HNO₃. In some embodiments of the disclosure, the powder is dissolved in H₂SO₄. The inorganic acid may be provided in an amount that removes (e.g., leaches) one or more materials (e.g., one or more metals and compounds) from the dissolved powder. That is, the inorganic acid may be provided in an amount that selectively removes (e.g., leaches) one or more materials (e.g., one or more metals and compounds) from the powder. By way of example only, the concentration of the inorganic acid may be from about 0.25 Molar (M) to about 1 M. In embodiments of the disclosure, the inorganic acid is from about 0.25 M H₂SO₄ to about 1 M H₂SO₄.

By way of example only, for the half-cell recycling, the remaining half-cell after cathode separation may be mechanically milled and ground into a micron-scale powder, sieved, and dried at 120° C. Nickel, such as from the obtained NiO—BZCYYb powder, may be leached using acid dissolution to produce a high purity NiO. The method avoids contamination during electrolyte recovery.

The method may comprise comminution to prepare a powder form of the SOE (e.g., a full-cell powder or a half-cell powder), and removing one or more materials (e.g., one or more metals and compounds) from the powder. Removing may comprise removing by one or more of acid leaching, electrochemical leaching, precipitation, ion exchange, and solvent extraction. Acid leaching may comprise adding an acid to the powder formed by comminution of the full-cell or half-cell. For example, an acid (e.g., H₂SO₄) may be added to the powder, dissolving the powder to form a leaching solution (e.g., leachate). One or more materials (e.g., elements, metals) may be removed (e.g., extracted, precipitated, removed by ion exchange or solvent extraction) from the formed leaching solution. One or more elements or compounds may be converted in the leaching solution (e.g., converting one or more of Ni, Co, Mn, NiO, CoO, and MnO to NiSO₄, MnSO₄, CoSO₄ and H₂O) to form a second leaching solution (e.g., a pre-purified leaching solution). Impurities may be removed from the pre-purified leaching solution, such as by using an electrochemical membrane reactor, forming a purified leaching solution.

Precipitation may be used to precipitate one or more metals or one or more compounds from the leaching solution (e.g., first leaching solution, second leaching solution). For example, the method may comprise adding sodium hydroxide, ammonium hydroxide, or a combination thereof to the leaching solution to precipitate one or more of nickel oxide, cobalt oxide, sodium oxide, and Na₂Pr(SO₄)₂ from the leaching solution. A base, such as one or more of ammonium hydroxide (NH₄OH) and NaOH, may be added to the leaching solution (e.g., second leaching solution) to co-precipitate one or more of praseodymium, nickel, manganese, and cobalt to form a mixed metal oxide, such as praseodymium oxide. Additional methods including ion exchange and solvent extraction may be employed to separate elements or compounds from solution as known in the art.

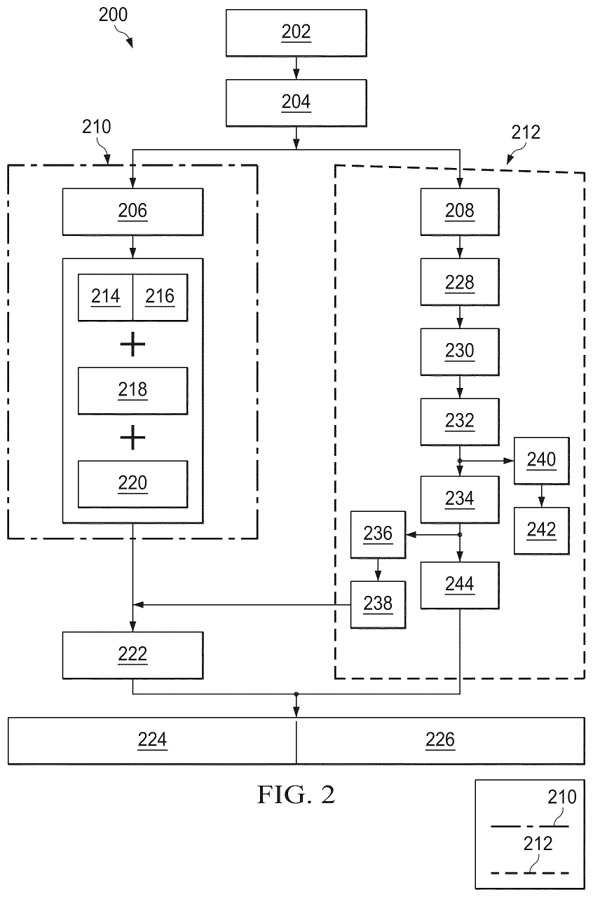

An embodiment of the disclosure will now be described with reference to FIG. 2, which shows a process flow (also termed a “flowsheet”) of the method for recovering one or more materials (e.g., chemical compounds, metals) from a solid oxide electrolyzer including separating a full-cell into a cathode and a half-cell (e.g., anode and electrolyte). Each of the cathode and the half-cell may be further processed as described below. The solid oxide electrolyzer full-cell may comprise a proton-conducting solid oxide electrolyzer. By way of example only, the proton-conducting solid oxide electrolyzer may include a praseodymium (Pr)-nickel-(Ni)-cobalt (Co) oxide cathode (PNC, e.g., PrNi_{0.5}Co_{0.5}O_{3-δ}), a barium (Ba)-cerium (Ce)-zirconium (Zr)-yttrium (Y)-ytterbium (Yb) electrolyte (BZCYYb, e.g., BaCe_{0.7}Zr_{0.1}Y_{0.1}Yb_{0.1}O_{3-δ}), and a nickel oxide-BZCYYb composite anode. However, the method 200 may be used with other combinations of materials as the electrolyte and electrodes. The method 200 may include the acts of providing a solid oxide electrolyzer full-cell 202 (e.g., a proton-conducting full-cell such as a NiO—BZCYYb/BZCYYb/PNC full-cell). The full-cell may be at its end of life or otherwise suitable for use in the recovery process. The method may include separating 204 the cathode from the full-cell (e.g., mechanical detachment of the cathode), forming a separated cathode material 206 (cathode material, PNC), and forming a half-cell material 208 (e.g., NiO and BZCYYb). The method may include the acts of recovering one or more of chemical compounds and metals from the cathode 210 and recovering 212 one or more of chemical compounds and/or metals from the half-cell.

Cathode recycling 210 may include preparing a cathode leaching solution 214 (e.g., a leaching solution comprising one or more of Co, Pr, and Ni) from the separated cathode and recovering (e.g., electrochemically leaching) one or more metals 216 (e.g., one or more of Co, Pr, and Ni) from the leaching solution. Recovering one or more metals 216 may include one or more of electrochemically leaching the one or more metals from the leaching solution, conducting a solvent extraction 218 (e.g., selective solvent extraction) of the one or more metals, and precipitating 220 the one or more materials (e.g., precipitation of cathode precursor materials). In embodiments of the disclosure, one or more materials (e.g., one or more metals) may be recovered using electrochemical leaching. The method may further comprise forming cathode materials 222 (e.g., PNC perovskite synthesis) using one or more of the recovered metals or materials obtained from the cathode recycling method 210. The cathode precursor materials may, for example, be used to form a material of the cathode, such as by a sol-gel process. A solid oxide electrolyzer (e.g., cell) may be formed 224 (e.g., manufactured) using the recycled cathode material and the recycled cathode material and/or solid oxide electrolyzer prepared therewith may subsequently be characterized 226 (e.g., evaluated). The characterization of the resulting solid oxide electrolyzer may be conducted by conventional techniques, such as by X-ray diffraction (XRD), scanning electron microscopy (SEM), transmission electron microscopy (TEM), or energy-dispersive X-ray spectroscopy (EDS). Properties such as sinterability, surface and cross-section morphology, and V-I response, resistance, and durability may be determined to ensure the solid oxide electrolyzer exhibits a desired electrochemical performance, comparable to or better than that of a solid oxide electrolyzer formed by conventional techniques.

Half-cell recycling 212 may include comminuting 228 (e.g., ball milling and sieving) the solid oxide electrolyzer half-cell (e.g., NiO and BZCYYb half-cell) producing a powder 230 (e.g., a NiO and BZCYYb powder). Act 232 may comprise dissolving the powder (e.g., acid dissolution), forming leaching solution 234. For example, the method may include producing a powder 230, dissolving the powder 232 in acid (e.g., HNO₃), and forming a solution 234 comprising BZCYYb and Ni²⁺ ions in HNO₃. The method may include heating 236 the solution and removing one or more metal oxides 238 (e.g., NiO), such as by precipitation. The NiO may be recycled (e.g., used for cathode material synthesis 222). Acid recycling/reusing 240 (e.g., HNO₃ recycling) may be conducted such as for separating 242 the electrolyte from the solution and forming electrolyte powder 244 (e.g., BZCYYb powder). The electrolyte powder may be used to prepare a new solid oxide electrolyzer.

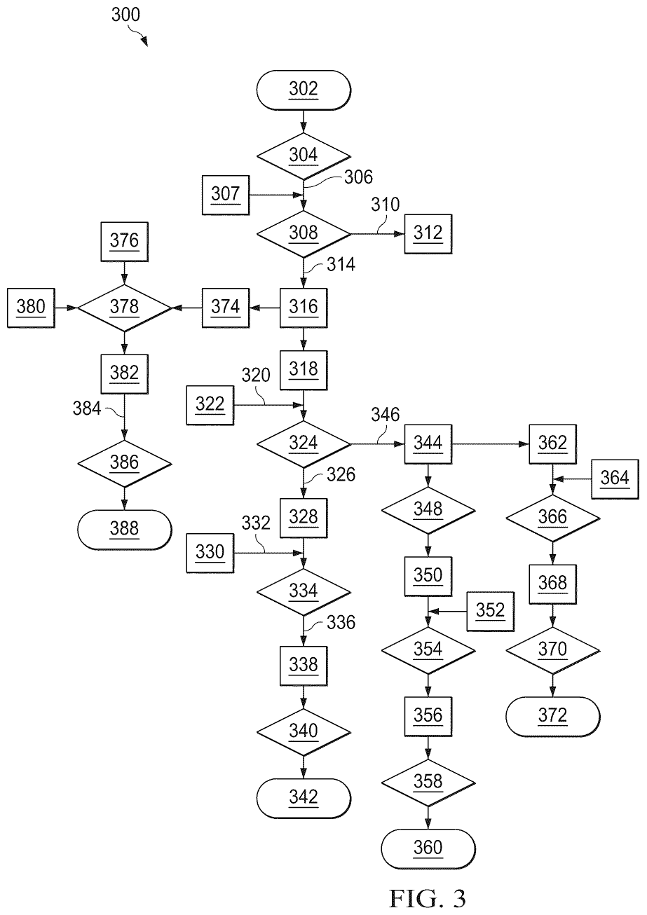

FIG. 3 shows a process flow of the method for recovering a material (e.g., chemical compounds, metals) from a solid oxide electrolyzer full-cell. The method 300 may, for example, comprise obtaining waste full-cells 302 (e.g., waste solid oxide electrolyzer full-cells) and comminuting 304 the solid oxide electrolyzer full-cells (e.g., comminuting both the cathode and the half-cell together) to produce a powder 306 (e.g., producing a full-cell powder). Adding 307 an acid (e.g., 0.5 M H₂SO₄) dissolves the powder, forming a leaching solution 308 (e.g., an acid leaching solution). One or more materials (e.g., elements, metals) may be removed (e.g., extracted, precipitated, removed by ion exchange or solvent extraction) from the formed leaching solution. The method may comprise recovering 310 electrolyte to produce 312 a so-called “leftover” solid (e.g., recovering solid(s) BaZr_{0.4}Ce_{0.4}Y_{0.1}Yb_{0.1}O₃ (BZCYYb4411)). Act 314 may comprise recovering one or more metals (e.g., one or more of Pr, Ni, and Co) (e.g., leaching one or more metals) from the acid leaching solution forming a liquid (1) leachate 316 comprising one or more materials (e.g., one or more metals, one or more metal oxides, one or more of Pr, Ni, and Co) in leachate, which may be further processed. A first process flow 318 (Process Flow 1) of the method 300 may form one or more metal oxides (e.g., separately form one or more of PrOₓ (s), NiO (s), and CoOₓ (s)) and may comprise adding 320 a salt 322 (e.g., 0.5 M Na₂SO₄) to the leachate, mixing and heating 324 to form 326 one or more metal sodium sulfate solids 328 (e.g., Na₂Pr(SO₄)₂ (s)). Providing a precipitating agent 330 (e.g., 2-5 M NaOH) and adding 332 the precipitating agent to the solid 328, followed by mixing and heating 334 to recover 336 (e.g., by precipitation) one or more compounds 338 (e.g., Pr(OH₃)(s)). The recovered one or more compounds 338 may be calcined 340 forming one or more rare earth metal oxides 342 (e.g., PrOₓ(s)).

Following mixing and heating 324, a filtrate 344 comprising one or more metals (e.g., one or more of Ni, Co, Na(l)) is obtained 346. The liquid (l) filtrate 344 may be treated 348 (e.g., by ion exchange) forming 350 one or more metal compounds (e.g., NiSO₄). Adding 352 one or more metal hydroxides (e.g., NaOH) to the one or more metal compounds 350 with mixing 354 may form 356 one or more metal hydroxides (e.g., Ni(OH)₂). The one or more metal hydroxides may be calcined 358, forming 360 one or more metal oxides (e.g., NiO(s)). Combining 362 excess liquid (e.g., excess Na, Co (l)) from the obtained filtrate 344 comprising one or more metals (e.g., one or more of Na and Co) and combining 364 with sodium hydroxide and mixing 366 may form 368 one or more metal hydroxides (e.g., Co(OH)₂ (s)). The one or more metal hydroxides may be calcined 370 to form 372 one or more metal oxides (e.g., CoOₓ (s)). The method 300 comprising Process Flow 1 may achieve a recycling percent recovery of 95 percent or more for PrOₓ, up to about 80 percent for NiO, and up to about 80 percent for CoOₓ of the materials present in the comminuted powder.

A second process flow 374 (Process Flow 2) of the method 300 may comprise adding 376 a hydroxide to the formed leachate (316) or adding 380 a hydroxide to a solution comprising one or more metals (e.g., one or more of Pr, Ni, and Co) and mixing 378 to recover 382 (e.g., precipitate, co-precipitate) one or more compounds, forming 384 one or more recovered compounds. The one or more recovered compounds may be calcined 386, forming 388 one or more metal oxides (e.g., PNC oxide, praseodymium (Pr)-nickel-(Ni)-cobalt (Co) oxide). The method 300 comprising Process Flow 2 may achieve a recycling percent recovery of 95 percent or more of PNC oxide present in the comminuted powder.

The method comprises electrochemical leaching (ECL) acts which may provide a lower chemical consumption and a lower energy consumption as compared with conventional methods. Reactions may be carried out under electrical and chemical conditions which may produce desired products within a shorter period of time as compared with conventional methods.

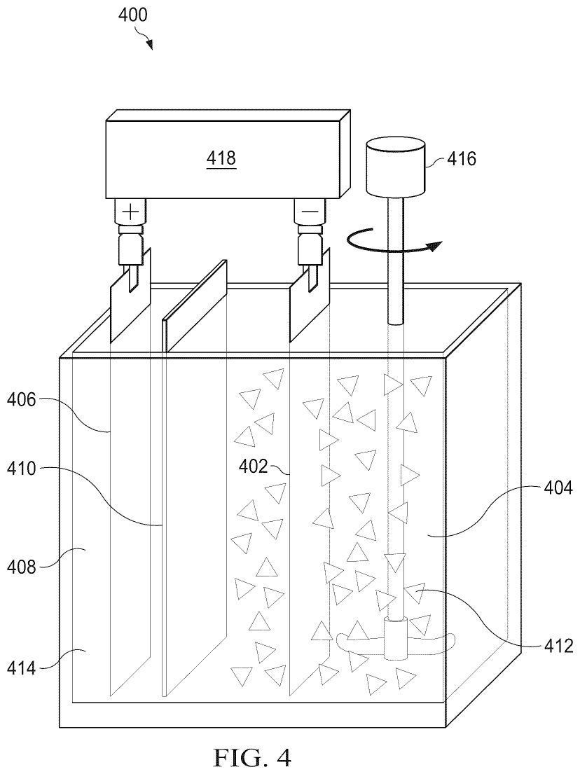

An electrolytic cell employed for the electrochemical leaching may be used for commercial applications or customized for research applications. FIG. 4 shows a cell 400 for electrochemical leaching in accordance with embodiments of the disclosure. Cell 400 includes a cathode 402 in a catholyte chamber 404, an anode 406 in an anolyte chamber 408, and a membrane (e.g., bipolar membrane) 410 separating the cathode 402 and anode 406. The catholyte chamber 404 includes a catholyte 412 comprising a diluted acid solution (e.g., H₂SO₄). The anolyte chamber 408 may comprise a solution 414 such as an aqueous KOH solution. The cathode 402 may be formed of and include any suitable material as known in the art, for example, stainless steel, titanium, platinum, among others. By way of example, the cathode may comprise stainless steel mesh. The anode 406 may be formed of and include any suitable material as known in the art, for example, platinum, IrO₂, titanium, coated titanium, among others. By way of example, the anode may comprise IrO₂ plated titanium mesh. An overhead motor 416 may be connected (e.g., inserted into) to the catholyte chamber 404 for applying agitation to the catholyte 412. A mesh protector (not shown) may be inserted on the cathode side of the membrane 410 to reduce or avoid mechanical failures due to sharp particles. The cell 400 may be any suitable or desired size. The volume of the electrolyte chambers (e.g., catholyte chamber 404 and anolyte chamber 408), the surface area of the electrodes (e.g., cathode 402 and anode 406), and crossing area (e.g., cross-sectional area) of the membrane 410 may be selected based on the operational needs of the leaching solution being treated. Parameters including acid concentration, pulp density (mass of solids per liquid in a unit volume, e.g., grams/liter), applied voltage, current, and other parameters may be selected based on the components of the leaching solution being treated. By way of example, catholyte 412 may comprise 0.5 M H₂SO₄ at a pulp density of 20 grams/liter of ground (e.g., comminuted) spent cell. By way of example, the anolyte 414 may comprise 1 M KOH. The anolyte 414 and catholyte 412 may be separated by the bipolar membrane 410 (e.g., a FUMASEP® FBM-PK bipolar membrane). Leaching occurs in the cathodic chamber. The starting catholyte may be, for example, an acidic solution (e.g., 0.5 M H₂SO₄) containing the reducing agent. The spent cell (e.g., comminuted spent cell powder) is added to the catholyte 412, and charge is applied between the cathode 402 and the anode 406. In operation, a potentiostat 418 may be used to apply a voltage (e.g., a 3-volt cell voltage) between the anode 406 and cathode 402 for a period of time (e.g., about 2 hours). After the leaching process, undissolved solids may be separated from the liquid phase such as by vacuum filtration.

By recovering the CRMs from waste or otherwise spent SOCs and reusing the recovered CRMs to form components of new SOCs, the methods according to embodiments of the disclosure may be more environmentally sustainable and conserve resources compared to conventional techniques. The circular manufacturing of SOCs using the recovered materials may be achieved without substantial compromises on electrochemical performance of the SOC. The new SOCs may, for example, be used to produce hydrogen from water electrolysis powered with carbon-free renewable energy. The methods according to embodiments of the disclosure may also provide economic efficiency and advancement in green technologies, which may benefit a wide range of stakeholders from environmental bodies to businesses and the scientific community. This may not only reduce waste and minimize the need for virgin materials but may also promote sustainability in the manufacturing process. The methods according to embodiments of the disclosure may be used to produce both o-SOE and p-SOE, which have been demonstrated for highly efficient green hydrogen production at elevated temperatures.

The methods according to embodiments of the disclosure may be a carbon neutral process of hydrogen production. The recovered materials may be used as a starting material or a precursor material of one or more components of an SOC, such as the anode, electrolyte, or cathode. The resulting SOE may be used for hydrogen production via water electrolysis, which is powered by a carbon-neutral source.

The following examples serve to explain embodiments of the disclosure in more detail. These examples are not to be construed as being exhaustive or exclusive as to the scope of this disclosure.

### EXAMPLES

### Fabrication Process for PCEC.

An electrode support layer was prepared by tape casting. First, NiO (Alfa Aesar) and homemade BaCe_{0.4}Zr_{0.4}Y_{0.1}Yb_{0.1}O_{3-δ} were mixed in a jar with ethyl alcohol, toluene, fish oil (The Tape Casting Warehouse, USA), polyvinyl butyral (The Tape Casting Warehouse, USA), and butyl benzyl phthalate (The Tape Casting Warehouse, USA) by ball milling for 48 hours to obtain a homogeneous slurry. The obtained slurry was degassed and tape casted to form a green-body tape which served as fuel electrodes. An electrolyte layer was deposited on the electrode support layer by ultrasonic spray coating (USC) at room temperature followed by sintering at 1470° C. for 5 hours to yield a half-cell.

To prepare full-cells, a slurry containing synthesized PrNi_{0.7}Co_{0.3}O_{3-δ} (PNC) powders, ethanol, and a texanol-based binder was screen printed onto the electrolyte surface of the half-cell. The painted cells underwent heat treatment at 1100° C. for 2 hours, resulting in a porous layer with a thickness of about 20 μm. Proportional incorporation of NiO was implemented to offset the quantity loss, ensuring that the weight ratio of NiO to BZCYYb remained at 6:4. The same fabrication process was used for both pristine and recycled cells.

### Comminution Process.

The scraps, identified as non-functional cell waste, underwent comminution to assess the impact of processing time on particle size and morphology. Comminution of electrode-supported half-cell scraps was first performed in a cryogenic rotor mill (MTI Corporation) at temperatures equal to or below −20° C., utilizing stainless steel impellers and vessels. Milling times of 0.5, 2, and 4 hours were carried out, employing ZrO₂ balls and liquid nitrogen as the grinding medium. An alternate method, planetary ball milling, using an MSE Supplies machine with TEFLON™ vessels was also carried out, which uses ZrO₂ balls and ethanol as the dispersant at 300 rpm. Periodic sampling every 4 to 8 hours was done which allowed for particle analysis. The ethanol dispersant and extended milling time elucidated the influence of these parameters on the resulting comminuted material. The comminution parameters are listed in Table 1.

TABLE 1
Technical Parameters During Comminution Process

| | Cryogenic | Planetary |
|---|---|---|
| | rotor milling | ball milling |
| Milling time (h) | 0.5; 2; 4 | 4 to 48 |
| Impeller material | Stainless steel | N/A |
| Vessel material | Stainless steel | Teflon ™ |
| Grinding medium | N₂ | Ethanol |
| Balls material | ZrO₂ | ZrO₂ |
| Milling temperature | ≤−20° C. | ~25° C. |

### Characterization and Performance Validation.

The particle size distribution (PSD) of the milled powders was analyzed using dynamic light scattering (DLS) with a particle size analyzer (Litesizer® 100, Anton Paar). NiO—BZCYYb powders were suspended in ethanol at a concentration of 1 weight % and then sonicated in a bath sonicator for 1 minute. Following sonication, particle size measurements were promptly conducted at room temperature (25° C.) with a wavelength of 658 nanometers (nm) and a backscatter angle of 175°. While DLS measurements are ideally suited for spherical particles, they can still offer insights for non-spherical particles. The calculated size may represent an equivalent spherical diameter rather than the actual particle size.

The phase purity was examined via X-ray diffraction (XRD) with a 2θ range from 20° to 80°, using an X-ray diffractometer (Bruker® D8® ADVANCE™) equipped with a Ni-filter Cu Kα radiation source. Scanning electron microscopy (SEM, JEOL 6700F) was utilized to analyze the cross-sectional morphology of the sintered cells. The porosity analysis of the sintered electrode support before and after reduction was performed using ImageJ software. Initially, a suitable threshold was applied to segment the pores from the background matrix in the SEM images. Subsequently, the area occupied by pores relative to the total area of the SEM image was quantified by counting the number of pixels representing pores and dividing by the total number of pixels in the image. Statistical analysis was then conducted to determine the mean porosity. The dynamic sintering curve of the half-cell was characterized using a dilatometer (DIL 402, Netzsch®).

For electrochemical performance validation, Ø2.54 (1″) cm button cells with a 20 μm PNC cathode, a 10 μm BZCYYb electrolyte, and a 450 μm NiO—BZCYYb composite anode were used. These cells, with an active area of 1.27 cm², were sealed in a custom reactor using Aremco CERAMABOND™ 552 sealant, with the cathode-side positioned upward. Silver wires were affixed to both the cathode and anode as leads. The assembly was then heated to the target temperature with a ramp rate of 3° C./minute. Initially, the sealant was annealed and the cell reduced at 600° C., while concurrently monitoring the open circuit voltage (OCV).

Subsequently, when the OCV stabilized, electrochemical measurements were obtained. During fuel cell mode, the PNC oxygen electrode was exposed to ambient air, while the hydrogen electrode encountered hydrogen (60 sccm, 3% steam). In electrolysis mode, the oxygen electrode was exposed to humidified air (120 sccm, 30% steam), while the hydrogen electrode interacted with pure hydrogen (60 sccm). Electrochemical testing utilized a Solartron® 1400 electrochemical workstation to obtain performance data, including current-voltage characteristic curves and electrochemical impedance spectra. The ohmic resistance and polarization resistance of the PCECs were derived from the electrochemical impedance spectra.

### Effects of Comminution.

Particle-size reduction (or comminution) is an important step in the ceramics industry. The process itself may be defined as mechanical crushing of solid sheets into particles without changing their aggregate state. A cryogenic rotor mill (CRM) was used to comminute the half-cells into micro-scale particles, followed by planetary ball milling to further grind the particles into hundreds of nano-meters scale, which has been identified as the PSD range of pristine composite NiO—BZCYYb. The comminution outcomes may depend on several factors including ratios of balls to powder, mechanical properties of the balls, and comminution time. In embodiments of the disclosure, we specifically focused on the effect of comminution time on the particle size reduction.

The effect of CRM milling time on half-cell comminution, ranging from 0.5 hour to 2 hours, achieved a certain PSD. The average particle size of the half-cell powders experienced a significant reduction within the initial 1 hour of CRM treatment. The D50 value decreased to 3.47 μm in 0.5 hour and further to 2.21 μm in 2 hours. Subsequent milling from 2 hours to 4 hours showed no substantial change in PSD, stabilizing the D50 value at 2.12 μm. Consequently, considering both particle size uniformity and time efficiency, 2 hours was determined as an optimal CRM time for the comminution of cell scrap before proceeding to planetary ball milling (PBM) for further refinement.

PBM effectively reduced the average particle size of the NiO—BZCYYb mixtures to 568 nm after 24 hours of milling. The standard deviation (indicated by error bars) of the average particle size decreased with prolonged PBM time, signifying a narrowing PSD. However, extending PBM time to 48 hours led to an unexpected increase in particle size, as highlighted in yellow, as well as the standard deviation.

The comminuted powders demonstrated an alignment in PSD with the pristine powders. Recycled NiO—BZCYYb exhibited a D50 value (568 nm) comparable to the pristine material (575 nm), albeit with a slightly narrower distribution. Additionally, in line with the particle size analysis, BET surface area measurements were conducted, revealing a consistent increase in specific surface area (SSA) from 1.12 to 2.23 m² g⁻¹ as ball milling time extended up to 24 hours. This augmentation in surface area predominantly stems from reduced particle size and a more confined size distribution. However, like the PSD trend, PBM time displayed adverse effects on SSA after 24 hours. A two-sample t-test was conducted comparing the particle size and BET data at 24 hours and 48 hours. Both resulting p-values exceeded 0.05, leading to the rejection of the null hypothesis. Consequently, it is challenging to assert that further PBM time up to 48 hours significantly impacted both particle size and SSA. Considering the associated time cost, a milling time of 24 hours in duration may be selected in embodiments of the disclosure. XRD patterns validated the phase consistency of recycled NiO—BZCYYb materials. SEM characterization of both pristine and recycled powders was demonstrated. The particle morphology observed was non-spherical, which is typical for composite materials, especially following mechanical treatments like ball milling. PSD and BET analysis results for NiO, BZCYYb, and their mixtures, including both pristine and recycled samples, are shown in Table 2.

TABLE 2
Average D50 and SSA of Raw and
Recycled NiO-BZCYYb Material

| | | Specific Surface |
|---|---|---|
| Sample | D50(nm) | Area (m²/g) |
| BZCYYb powder | 525 | 2.38 |
| NiO powder | 707 | 1.35 |
| Pristine NiO-BZCYYb | 576 | 2.17 |
| Recycled NiO-BzCYYB | 568 | 2.23 |

Following the comminution process, the PSD and SSA of the recycled material aligned closely with those of the raw powders. There was a coherence in both the PSD and SSA parameters of the recycled material post-milling, mirroring the characteristics of the original powders. This observation indicated that the comminution process effectively achieved its objective of aligning the PSD and SSA of the recycled NiO—BZCYYb material with the pristine powders utilized in cell manufacturing, while avoiding any alterations in phase purity.

### Sinterability of Recycled NiO—BZCYYb Powders.

Following comminution and NiO compensation, the NiO—BZCYYb mixture powders were used to prepare slurries for tape casting. Subsequently, the green tapes were laminated and electrolyte layers were deposited using ultrasonic spray coating, followed by high-temperature co-sintering at 1450° C. The sintering behavior of both the pristine and regenerated half-cells was characterized via dilatometry.

Elongation (change in length/original length, ΔL/Lo) was plotted as a function of temperature, employing a heating rate of 3° C. per minute. At 1450° C., both powders exhibited similar elongation values, with −18.3% for pristine and −18.7% for regenerated. These findings show the consistent shrinkage rate of the half-cell with recycled NiO—BZCYYb powders, a factor that enhances reproducibility and quality control in cell manufacturing processes.

Cross-sectional images of the half-cell coupons after sintering, revealed dense electrolyte layers without any discernible defects or pinholes in both types of cells. However, a noticeable contrast emerged in the distribution of NiO particles. The regenerated half-cell showed a more uniform distribution of NiO particles with narrowed particle sizes distributions. This discrepancy may account for the variation in elongation observed between 1200° C. and 1350° C., wherein the regenerated half-cell demonstrated higher sinterability, as evidenced by its greater elongation. Throughout the sintering process of the half-cell, neck formation transpired at grain boundaries between particles, reflecting interactions reminiscent of those among spherical entities. Consequently, a smaller particle size or higher surface area of the electrolyte powders may yield enhanced sintering activity. The consistency observed in the sinterability of half-cells aligned with the similarities in particle size distribution and specific surface area data as outlined in Table 2.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method for recovering a material from a solid oxide full-cell, the method comprising:
comminuting a solid oxide full-cell to produce a powder;
dissolving the powder to form a leaching solution;
removing the one or more materials from the leaching solution; and
recovering the one or more materials.

2. The method of claim 1, where comminuting a solid oxide full-cell to produce a powder comprises comminuting a solid oxide full-cell to produce a powder comprising one or more of zirconia, yttria-stabilized zirconia, gadolinium-doped ceria, scandia-stabilized zirconia, lanthanum gallate, doped barium zirconate, yttria-doped barium zirconate, barium cerate-zirconate, barium-cerium-zirconium-yttrium-ytterbium, samaria-doped ceria, nickel, nickel oxide, praseodymium oxide, cobalt oxide, praseodymium-nickel-cobalt oxide, nickel-yttrium-stabilized zirconia, nickel-gadolinium doped ceria, cobalt, strontium, yttrium, cerium, lanthanum, lanthanum strontium manganite, and lanthanum strontium cobalt ferrite.

3. The method of claim 1, wherein comminuting a solid oxide full-cell to produce a powder comprises one or more of grinding, crushing, cutting, vibrating, milling, ball milling, roller milling, cold milling, cryogenic milling, knife milling, attritor milling, and planetary ball milling and sieving the solid oxide full-cell.

4. The method of claim 1, wherein comminuting a solid oxide full-cell to produce a powder comprises:
comminuting a solid oxide full-cell using a cryogenic rotor mill to produce micrometer sized particles; and
comminuting the micrometer sized particles using a planetary ball mill to produce nanometer sized particles.

5. The method of claim 1, wherein comminuting a solid oxide full-cell to produce a powder comprises comminuting one or more of an oxygen ion conducting solid oxide electrolyzer and a proton conducting solid oxide electrolyzer.

6. The method of claim 1, wherein dissolving the powder to form a leaching solution comprises dissolving the powder in one or more of H₂SO₄, HCl, and HNO₃.

7. The method of claim 1, wherein dissolving the powder to form a leaching solution comprising dissolving the powder in H₂SO₄ exhibiting a concentration of from about 0.25 Molar (M) H₂SO₄ to about 1 M H₂SO₄.

8. The method of claim 1, wherein removing one or more materials from the leaching solution comprises removing one or more materials by one or more of acid leaching, electrochemical leaching, precipitation, ion exchange, and solvent extraction.

9. The method of claim 1, wherein removing one or more materials from the leaching solution comprises removing one or more of a perovskite electrolyte material and a metal material from the leaching solution.

10. The method of claim 1, wherein recovering the one or more materials comprises recovering a transition metal, a transition metal compound, a rare earth element, a rare earth element compound, or a combination thereof.

11. The method of claim 1, wherein recovering the one or more materials comprises recovering one or more of cobalt, praseodymium, nickel, and oxides thereof.

12. The process of claim 1, wherein removing the one or more materials from the leaching solution comprises:
adding a salt to the leaching solution to form one or more metal sulfate compounds;
adding a precipitating agent to the one or more metal sulfate compounds and heating to form one or more metal compounds; and
recovering the one or more metal compounds.

13. The method of claim 12, further comprising:
calcining the one or more recovered metal compounds to form one or more of rare earth metal oxides and metal oxides.

14. The method of claim 13, wherein calcining the one or more recovered metal compounds to form one or more of rare earth metal oxides and metal oxides comprises calcining to form one or more of praseodymium oxide, nickel oxide, and cobalt oxide.

15. A method for recovering a material from a solid oxide full-cell, the method comprising:
comminuting a solid oxide full-cell comprising one or more of a perovskite electrolyte material and a metal material to produce a powder;
dissolving the powder in H₂SO₄ exhibiting a concentration of from about 0.25 Molar (M) H₂SO₄ to about 1 M H₂SO₄ to form a leaching solution;
removing the one or more of the perovskite electrolyte material and the metal material from the leaching solution; and
recovering one or more of the perovskite electrolyte material and the metal material.

16. A method for recovering a material from a solid oxide cell, the method comprising:
separating a cathode from a solid oxide half-cell of a solid oxide cell, the solid oxide cell comprising one or more of a perovskite electrolyte material, a metal material, cobalt, praseodymium, and nickel;
dissolving one or more of the cobalt, praseodymium, and nickel of the cathode into a first leaching solution;
removing the one or more of cobalt, praseodymium, and nickel from the first leaching solution;
comminuting the solid oxide half-cell to produce a powder;
dissolving the powder to form a second leaching solution; and
removing one or more materials from the second leaching solution.

17. The method of claim 16, wherein separating a cathode from a solid oxide half-cell of a solid oxide cell comprises separating the cathode from a solid oxide half-cell of a solid oxide cell comprising one or more of an oxygen ion conducting solid oxide electrolyzer and a proton conducting solid oxide electrolyzer.

18. The method of claim 16, wherein removing one or more materials from the second leaching solution comprises removing one or more of a perovskite electrolyte material and a metal material from the second leaching solution.

19. The method of claim 16, wherein:
dissolving one or more of cobalt, praseodymium, and nickel of the cathode into a first leaching solution comprises adding one or more of H₂SO₄, HCl, and HNO₃ to the first leaching solution; and
dissolving the powder to form a second leaching solution comprises adding one or more of H₂SO₄, HCl, and HNO₃ to the second leaching solution.

20. The method of claim 16, wherein separating a cathode from a solid oxide half-cell comprises mechanically separating the cathode from the solid oxide half-cell.

21. The method of claim 16, further comprising adding one or more of an oxidizing agent and a reducing agent to the first leaching solution to selectively dissolve the one or more of the cobalt, praseodymium, and nickel.

22. The method of claim 21, further comprising electrochemically generating one or more of hydrogen peroxide, iron, and cerium.
